(19) United States
(12) Patent Application Publication
(10) Pub. No.: US 2013/0337672 A1
(43) Pub. Date: Dec. 19, 2013

(54) ELECTRICAL CARD CONNECTOR

(71) Applicant: HON HAI PRECISION INDUSTRY CO., LTD., New Taipei (TW)

(72) Inventors: FANG-YUE ZHU, Kunshan (CN); YU-CHE HUANG, New Taipei (TW); JIN-KUI HU, Kunshan (CN)

(21) Appl. No.: 13/916,849

(22) Filed: Jun. 13, 2013

(30) Foreign Application Priority Data
Jun. 13, 2012 (CN) 201220276118.3

(51) Int. Cl. H01R 13/633

(52) U.S. Cl. CPC H01R 13/6335
USPC 439/159

(57) ABSTRACT

An electrical card connector includes an insulative housing, a plurality of contacts retained in the insulative housing, a push-push mechanism and a metal shell. The push-push mechanism includes a slider and a link rod. The slider has an outer surface at a laterally side thereof, a heart-shape groove with a heart-shaped block located in a middle thereof depressing from the outer surface and a straight guiding groove communicating with the heart-shape groove. The link rod has a first end portion assembled to the insulative housing and a second end portion sliding in the heart-shape groove and the straight guiding groove. The slider further has an engaging surface depressing from a part of the outer surface in front of the heart-shaped groove, and the heart-shape groove with the heart-shaped block is also retracted from the outer surface together with the engaging surface.

### BACKGROUND OF THE INVENTION

1. Field of the Invention

The present invention relates to an electrical card connector, more particularly to an electrical card connector with an improved push-push mechanism for reducing a size of the electrical card connector.

2. Description of Related Art

Electrical card connectors are usually mounted on a PCB of the electronic devices to establish data transmission between the electrical cards and the electronic devices. Usually, an electrical card connector sets a push-push mechanism for pushing an electrical card into or out of the electrical card connector. Such current electrical card connector includes an insulative housing, a plurality of contacts fixed in the insulative housing, a push-push mechanism and a metal shell covering the insulative housing. The push-push mechanism includes a slider moveable along the card insertion direction, a coiled spring abutting against the slider and a link rod for controlling positions of the slider. The metal shell has a top wall and two side bending walls bent from the lateral of the top wall. The bending wall has a flexible plate which is torn from the bending wall and has a free end abutting against with the link rod to prevent the link rod from dropping out of the slider. The slider has a heart groove on a lateral surface thereof, the link rod slides along the heart groove during an insertion of the corresponding electrical card into the memory card connector, the link rod may be push beyond the slider and force the flexible plate of the metal shell. As an example, in U.S. Pat. No. 6,520,784 issued to Ito et al. on Feb. 18, 2003, it is disclosed that a slider is received in a recess portion along a side portion of housing so that an eject mechanism does not project to the side of connector body, thus reducing the area occupied on an underlying substrate. See column 5, lines 21-28.

Hence, an improved electrical card connector with improved push-push mechanism is needed to solve the problem above.

### BRIEF SUMMARY OF THE INVENTION

An electrical card connector includes an insulative housing, a plurality of contacts retained in the insulative housing, a push-push mechanism and a metal shell covering the insulative housing. The insulative defining a receiving space for insertion of an electrical card. The push-push mechanism includes a slider moveable along a front to back direction, a coiled spring positioned between the slider and the insulative housing, and a link rod for controlling positions of the slider, the slider having an outer surface located outside of the card receiving space, a heart-shape groove depressing inside from the outer surface, a heart-shaped block located in a middle of the heart-shaped groove and a straight guiding groove communicating with the heart-shape groove, the link rod formed with a first end portion being assembled to the insulative housing and a second end portion sliding in the heart-shape groove and the straight guiding groove. The metal shell has a flexible plate abutting against with the second end portion of the link rod. Wherein the slider further having an engaging surface depressing from a part of the outer surface in front of the heart-shaped groove, and the heart-shape groove including the heart-shaped block is retracted from the outer surface together with the engaging surface for providing the second end portion a deeper space.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical card connector assembled to a printed circuit board according to the preferred embodiment of the present invention;

FIG. 2 is a partially exploded, perspective view of the electrical card connector;

FIG. 3 is an exploded, perspective view of the electrical card connector;

FIG. 4 is an enlarged view of the electrical card connector in a circuit of FIG. 2;

FIG. 5 is a top plan view of the electrical card connector with its metal shell removed therefrom;

FIG. 6 is a perspective view of a slider of the electrical card connector.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

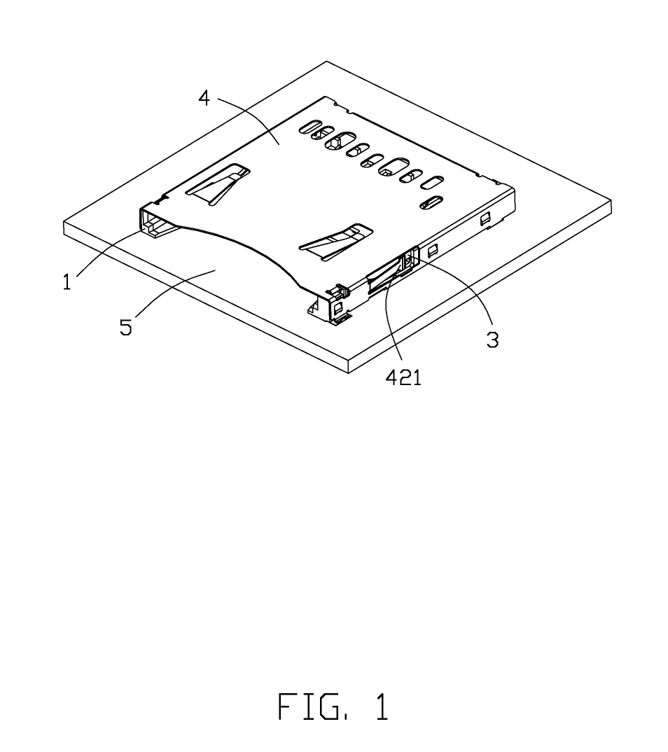

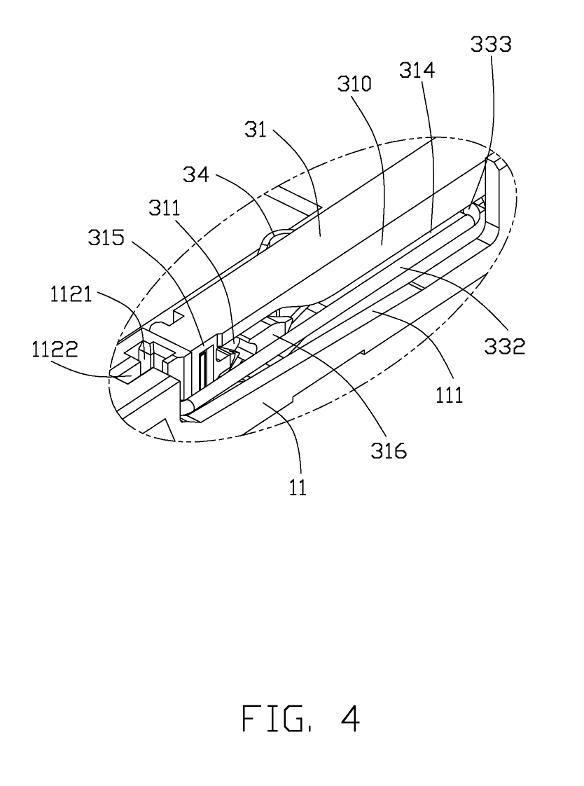

Referring to FIGS. 1-6, an electrical card connector 100 is attained in a printed circuit board 5 for insertion of an electrical card (not shown) is disclosed. The electrical card connector 100 includes an insulative housing 1, a plurality of contacts 2 retained in the insulative housing 1, a push-push mechanism 3 and a metal shell 4 covering the insulative housing 1.

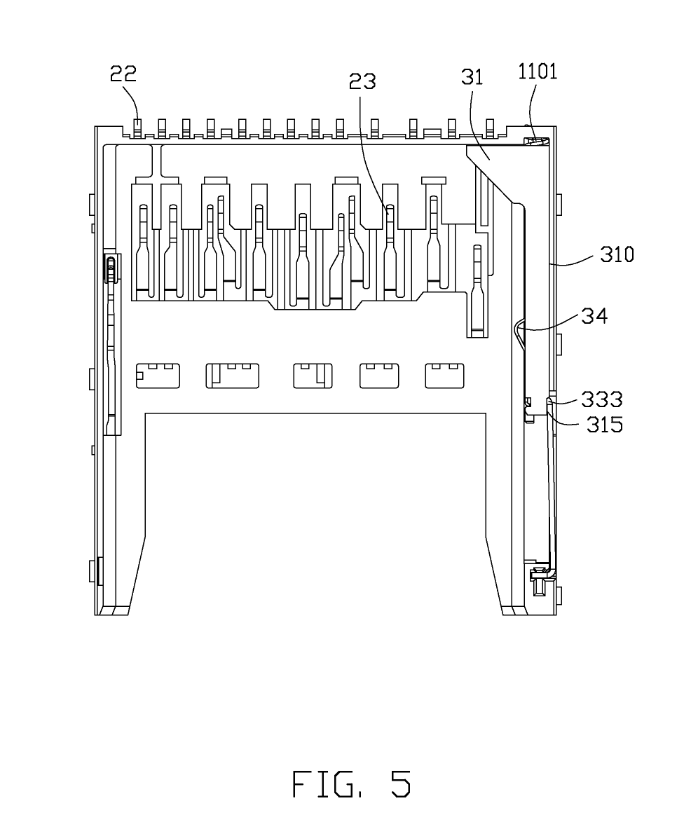

The insulative housing 1 includes a rear wall 10, two sidewalls 11 extending upwardly from a left side and a right side of the rear wall 10, a card receiving space 12 is formed between the rear wall 10 and the two side walls 11. The insulative housing 1 further includes a bottom wall 121 connecting with the two side walls 11 along a transverse direction. The bottom wall 121 is a hollow plate and formed with a plurality of separating plates 101 extending forwardly and connecting with a bottom end of the rear wall 10. The side wall 11 defines a receiving chamber 110 communicating with the card receiving space 12 and a protrusion post 1101 (refer to FIG. 5) forwardly extending into the receiving chamber 110 from the rear wall 10. The side wall 11 further includes a notch 111 extending through the side wall 11 along a transverse direction and located outside of the receiving chamber 110. The notch 111 is in communication with the receiving chamber 110. The side wall 11 has a top face and a recess depressed from the top face at a front end of the side wall 11 along an upper to down direction. The recess includes a receiving groove 1121 extending through the side wall 11 along the transverse direction and a limiting groove 1122 extending forwardly from a middle of the receiving groove 1121. A width of the limiting groove 1122 is smaller than that of the receiving groove 1121. The limiting groove 1122 does not extend through the side wall 11. Take a top plan view of the recess, the recess is shown in a T shaped. The two side walls 11 further has a plurality of locking blocks 13 for locking with the metal shell 4.

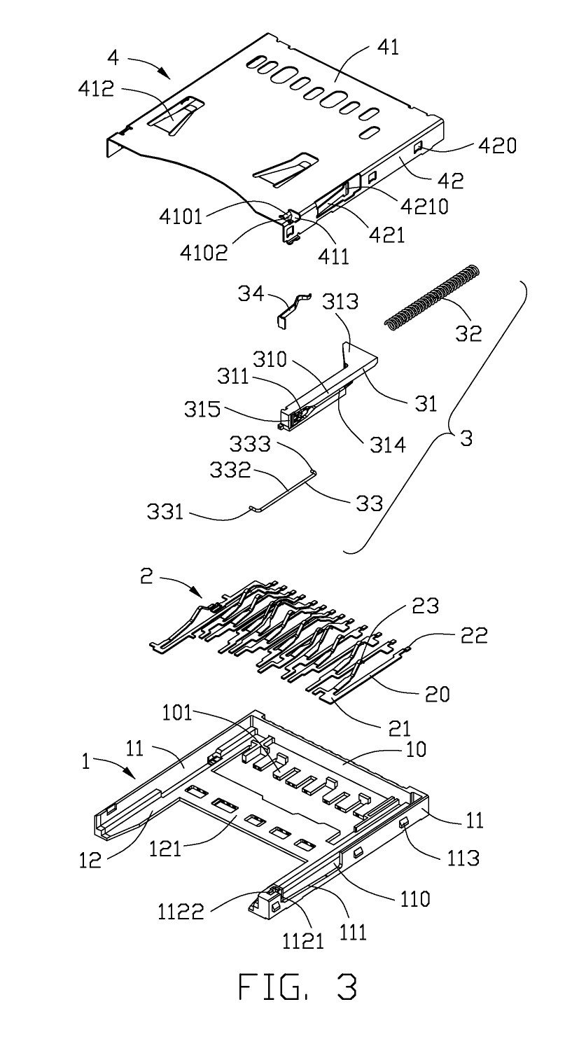

Please reference to FIG. 3, the contacts 2 are retained in the insulative housing 1 for mating with the electrical card and arranged on the insulative housing 1 along a transverse direction. Each contact 2 includes a connecting portion 20 exposed in the hollow of the bottom wall 121, a retaining leg 21 extending forwardly from a end of the connecting portion 20 and insert molded in the bottom wall 121, a soldering portion 22 extending backwardly from another end of the connecting portion 20 and retained in the separating plate 101 and a contact portion 23 cantileveredly extending backwardly from the retaining leg 21 and extending into the card receiving space 12. The soldering portion 22 further extends beyond the rear wall 10 to be soldered in the printed circuit board.

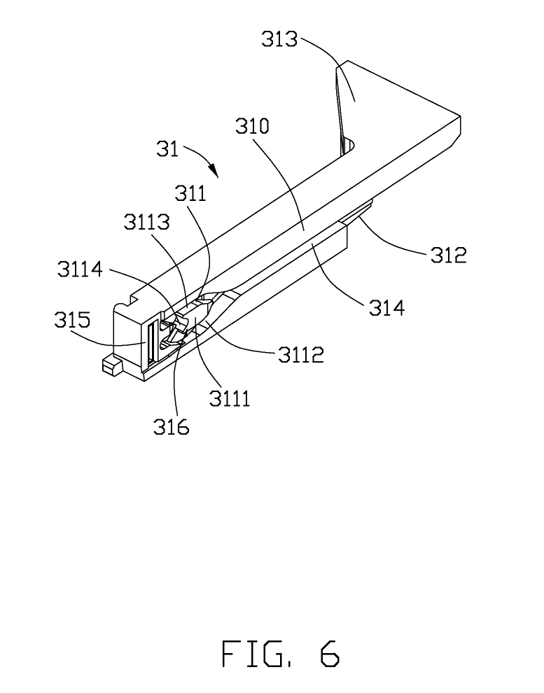

Reference to FIGS. 3 and 6, the push-push mechanism 3 includes a slider 31 moveable in the receiving chamber 110, a coiled spring 32 abutting against the slider 31, a link rod 33 for controlling positions of the slider 31, and a locking arm 34 retained in an inner side of the slider 31. The slider 31 includes a main body received in the receiving chamber 110 and a protrusion 313 laterally extending from a rear end of the main body into the card receiving space 12. The main body and the protrusion 313 form a L-shape frame approximately. The slider 31 has an outer surface 310 and a heart-shape groove 311 recessed from the outer surface 310, a heart-shape block 3111 is located in the middle of the heart-shape groove 311, a straight guiding groove 314 extending from the rear end of the slider 31 and connecting with the heart-shape groove 311, and a locking post 312 extending backwardly forward the protrusion post 1101 to position the coiled spring 32. The straight guiding groove 314 has a first bottom surface extending vertically for supporting the link rod 33. The heart-shape groove 311 has a second bottom surface extending vertically for supporting the link rod 33. The heart-shape groove 311 includes a first slot 3112 for guiding the link rod 33 to insert, a second slot 3113 for guiding the link rod 33 to withdraw and a locking slot 3114 connecting with the first and second slots 3112, 3113.

The slider 31 has a engaging surface 315 depressing from the outer surface 310 in front of the heart-shaped groove 311, the heart-shaped block 3111 has an assistant surface 316 on an outside thereof, the engaging surface 315 and the assistant surface 316 are both located in a vertical interface and in an inner side of the outer surface 310. The heart-shaped groove 311 including the first slot 3112, the second slot 3113 and the locking slot 3114 is retracted from the outer surface 310 together. The assistant surface 316 also retracted from the outer surface 310 as the same with the heart-shaped groove 311. In this arrangement, the first inner surface of the straight guiding groove 314 is much near to the outer surface than that of the second inner surface of the heat-shaped groove 311. One end of the coiled spring 32 surrounds the protrusion post 1101 and the other end of the coiled spring 32 is positioned around the locking post 312. The coiled spring 32 gives the slider 31 an elastic force to realize ejecting the electrical card from the electrical card connector 100.

The link rod 33 includes a middle portion 332, a first end portion 331 and a second end portion 333 laterally bending from opposite ends of the middle portion 331. The second end portion 333 is assembled to the straight guiding groove 314, the first end portion 331 is assembled to the receiving groove 1121. The middle portion 332 is exposed in the notch 111. The second end portion 333 is moveable in the heart-shaped groove 311. The electrical card connector 100 is so-called push-push type card connector and the working theory of the push-push mechanism 3 is obvious to those of ordinary skill in the art, so the detailed description is omitted hereinafter.

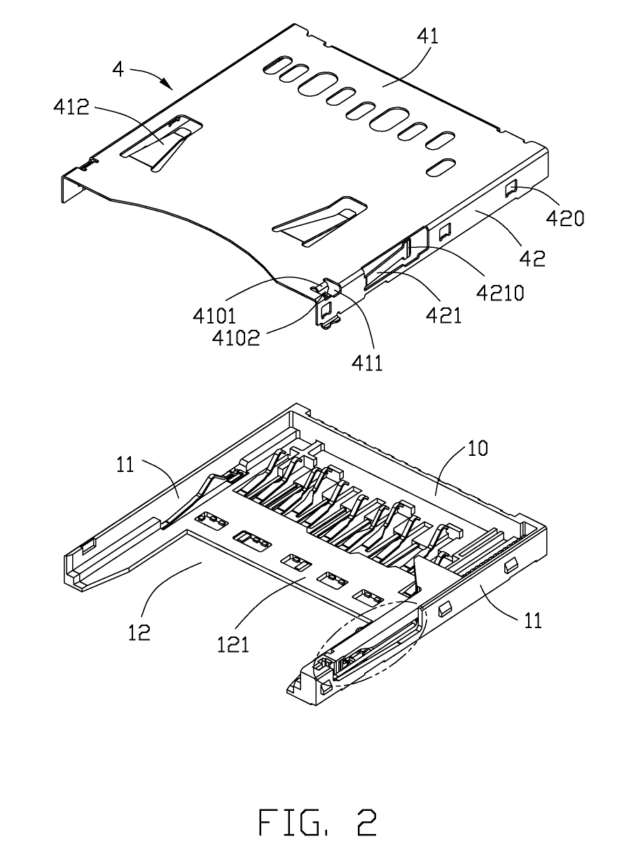

Reference to FIGS. 2 to 3, the metal shell 4 is stamped from a metal sheet and includes a top wall 41 and a pair of bending walls 42 extending downwardly from lateral sides of the top wall 41. The top wall 41 has a pair of first flexible plates 412 extending downwardly in to the card receiving space 12 for increasing insertion and extraction force of the electrical card. The bending wall 42 corresponding to the notch 111 of the side wall 11 has a second flexible plate 421 to engage with the link rod 33 for preventing the link rod 33 from droping out of the slider 31, and a plurality of locking holes 420 for locking with the locking blocks 113 of the insulative housing 1. The top wall 41 further has a tearing portion torn downwardly therefrom and a through hole 411 formed by tearing the tearing portion. The tearing portion has a bending portion 4101 connecting with the top wall 41 and a limiting portion 4102 extending from a bottom side of the bending portion 4101. The limiting portion 4102 is shown in a vertical plate with a plurality of lances located at two sides thereof. The limiting portion 4102 is parallel to and separated from the side bending wall 42. The limiting portion 4102 extends into the limiting groove 1122 and has a hole for the first end portion 331 of the link rod 33 rotating therein. The lances prevent the limiting portion 4102 from escaping out of the limiting groove 1122. The second flexible plate 421 has a free end 4210 abutting against with the link rod 33 to prevent the link rod 33 from running outwardly over the heart-shape groove 311.

Referring to FIGS. 1 to 6, when the electrical card is just inserted into the card receiving space 12, the front portion of the electrical card abuts against the protrusion 313 of the slider 31 and drives the slider 31 to move backwardly. The middle portion 331 is outwardly restricted by the second flexible plate 421 of the bending wall 42 in order to prevent the link rod 33 from falling off the side wall 11 of the insulative housing 1. Under such process, the second end portion 333 is moveable in the heart-shaped groove 311. When the electrical card is further inserted into the card receiving space 12 and reach the final locking/working position, the second end portion 333 reaches a locking location of the heart-shaped 311. During above processes, for the heart-shape groove 311 has a retracted distance, the engaging surface 315 and the assistant surface 316 are also retracted together with the heart-shape groove 311, when the link rod 33 sliding in the first bottom surface of the straight guiding groove 314, the free end 4210 of the second flexible plate 421 will not be pushed beyond the bending wall 42 of the metal shell 4 and make the electrical card connector 100 keep in a mini size.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical card connector comprising:
an insulative housing defining a receiving space for insertion of an electrical card;
a plurality of contacts retained in the insulative housing;
a push-push mechanism, the push-push mechanism having a slider moveable along a front to back direction, a coiled spring positioned between the slider and the insulative housing, and a link rod for controlling positions of the slider, the slider having an outer surface located outside of the card receiving space, a heart-shape groove laterally depressing from the outer surface toward the card receiving space, a heart-shaped block located in a middle of the heart-shaped groove and a straight guiding groove communicating with the heart-shape groove, the link rod formed with a first end portion being assembled to the insulative housing and a second end portion sliding in the heart-shape groove and the straight guiding groove; and
a metal shell covering the insulative housing and having a flexible plate abutting against with the second end portion of the link rod; wherein
the slider further has an engaging surface depressing from a part of the outer surface in front of the heart-shaped groove, the heart-shape groove including the heart-shaped block is also retracted from the outer surface together with the engaging surface for providing a deeper space for the second end portion.

2. The electrical card connector as claimed in claim 1, wherein the heart-shape block has an assistant surface which is also retracted related to the outer surface.

3. The electrical card connector as claimed in claim 2, wherein the assistant surface and the engaging surface are both located inside of the outer surface and are coplanar with each other.

4. The electrical card connector as claimed in claim 1, wherein the straight guiding groove has a first bottom surface for supporting the link rod, the heart-shape groove has a second bottom surface for supporting the link rod, a position of the flexible plate pushed by the link rod sliding on the second bottom surface of the heart-shaped groove is not beyond another position of the flexible plate when being pushed by the link rod sliding on the first bottom surface of the straight guiding groove, in other word, the position is inside the another position.

5. The electrical card connector as claimed in claim 1, wherein the insulative housing has a side wall defining a receiving chamber communicating with the card receiving space for receiving the slider, and a notch located outside of the receiving chamber, the notch extends through the side wall along a transverse direction for receiving the link rod, the outer surface is located outside of the side wall.

6. The electrical card connector as claimed in claim 5, wherein the flexible plate has a free end abutting against the link rod.

7. The electrical card connector as claimed in claim 6, wherein the coiled spring comprises one end abutting against the slider and the other end abutting against the insulative housing.

8. The electrical card connector as claimed in claim 6, wherein the side wall has a top face and a recess depressed from the top face at a front end of the side wall, the recess has a receiving groove extending through the side wall along the transverse direction and a limiting groove extending forwardly from a middle of the receiving groove.

9. The electrical card connector as claimed in claim 8, wherein a width of the limiting groove is smaller than that of the receiving groove, the recess is in a T shaped as observed from a top side.

10. The electrical card connector as claimed in claim 8, wherein the metal shell comprises a top wall and a pair of bending walls extending downwardly from lateral sides of the top wall, the top wall has a tearing portion which is formed by tearing and has a bending portion connecting with the top wall and a limiting portion extending from a bottom side of the bending portion, the limiting portion is parallel to the side bending wall.

11. An electrical card connector comprising:
an insulative housing defining a receiving space for insertion of an electrical card;
a plurality of contacts retained in the insulative housing; and
a push-push mechanism, the push-push mechanism comprising a slider moveable along a front to back direction, a coiled spring positioned between the slider and the insulative housing, and a link rod for controlling positions of the slider, the slider having an outer surface located outside of the card receiving space, a heart-shape groove laterally depressing inside from the outer surface toward the card receiving space and a straight guiding groove communicating with the heart-shape groove, the link rod having a middle portion located laterally outside of the insulative housing, the slider further having an engaging surface depressing from a part of the outer surface in front of the heart-shaped groove and defining a distance between the outer surface and the engaging surface; wherein
the heart-shaped groove having a heart-shaped block set in a middle thereof, the heart-shaped block having an assistant surface on an outside thereof, which is coplanar with the engaging surface and both located inside of the outer surface.

12. The electrical card connector as claimed in claim 11, wherein the insulative housing has a bottom wall, two side walls extending upwardly from two lateral sides of the bottom wall and the card receiving space formed therebetween, the side wall defines a receiving chamber to accommodate the slider.

13. The electrical card connector as claimed in claim 11, wherein the metal shell covers the insulative housing, the card receiving space is jointly defined by the metal shell and the insulative housing.

14. An electrical card connector comprising:
an insulative housing defining a card receiving space;
a plurality of contacts disposed in the housing with contacting sections exposed into the card receiving space;
a slider back and forth moveable beside the card receiving space;
a heart-shaped groove and a straight groove communicating with each other and formed in a side face of said slider;
a heart-shaped block formed in the heart-shaped groove; and
a linking rod with one fix end fastened to the housing and the other moveable end moveable along the groove; wherein
the heart-shaped groove is closer to said fixed end than the straight groove, and an exterior face of an end portion of the slider which is closer to said fixed end, and that of the heart-shaped block are both inwardly recessed from the side face of the remaining portions of the slider so as to leave enough space for allowing easy movement of said other moveable end of the linking rod when said other end is moved along said heart-shaped groove.
